(19) United States
(12) Patent Application Publication
(10) Pub. No.: US 2026/0218660 A1
(43) Pub. Date: Jul. 30, 2026

(54) HEATING INSTALLATION FOR AN AIRCRAFT COMPRISING A DIHYDROGEN TANK, AN ENGINE AND DIHYDROGEN HEATING SYSTEMS

(71) Applicant: Airbus Operations SAS, TOULOUSE (FR)

(72) Inventors: Mathieu BELLEVILLE, TOULOUSE (FR); Cédric KLEINERMANN, TOULOUSE (FR); Pierre-Olivier MARTIN, TOULOUSE (FR); Simon MENAGER, VERNON (FR); Louis Vianney MABILLE DE LA PAUMELIERE, VERNON (FR); Thierry BRICHLER, MOISSY-CRAMAYEL (FR); Nicolas Claude PARMENTIER, MOISSY-CRAMAYEL (FR)

(21) Appl. No.: 19/141,250

(22) PCT Filed: Dec. 20, 2023
(86) PCT No.: PCT/EP2023/087061

§ 371 Date: Jun. 19, 2025

(30) Foreign Application Priority Data
Dec. 20, 2022 (FR) FR2213952

(51) Int. Cl. F02C 7/224; B64D 27/16; B64D 37/02; B64D 37/30; B64D 37/34

(52) U.S. Cl. CPC F02C 7/224; B64D 27/16; B64D 37/02; B64D 37/30; B64D 37/34

(57) ABSTRACT

A heating installation for an aircraft disposed between a dihydrogen tank and an engine with a first supply line connected to the tank and a second supply line connected to the engine and comprising two branch lines connected parallel to each other between the first supply line and the second supply line. Each branch lines includes a first valve, a heating system and a second valve installed in series, upstream to downstream.

### CROSS-REFERENCES TO RELATED APPLICATIONS

This application claims the benefit of International Application Number PCT/EP2023/087061 filed on Dec. 20, 2023, which claims priority to French Patent Application No. FR2213952 filed on Dec. 20, 2022, the entire disclosures of which are incorporated herein by way of reference.

### FIELD OF THE INVENTION

The present invention relates to a heating installation for an aircraft comprising a dihydrogen tank, an engine consuming dihydrogen and two heating systems arranged on two lines installed parallel to each other in order to heat the dihydrogen exiting the tank before it is introduced into the engine. The present invention also relates to an aircraft comprising such a heating installation.

### BACKGROUND OF THE INVENTION

An aircraft conventionally comprises engines for moving said aircraft. These engines are conventionally supplied with a fuel for the operation thereof. In order to reduce the carbon footprint, it is known for dihydrogen to be used as fuel for operating the engines.

An aircraft then comprises a tank for storing the dihydrogen, in particular liquid dihydrogen, and a heating system that notably changes the phase of the dihydrogen in order to supply each engine with gaseous dihydrogen.

Although such installations are satisfactory, an arrangement needs to be found where the heating is redundant in order to ensure that more dihydrogen is available for the engine if necessary.

### SUMMARY OF THE INVENTION

An aim of the present invention is to propose a beating installation for an aircraft comprising a dihydrogen tank, an engine and at least two heating systems arranged on lines installed parallel to each other in order to heat the dihydrogen exiting the tank before it is introduced into the engine.

To this end, according to the invention, a heating installation is proposed for an aircraft comprising a tank that stores dihydrogen, an engine, a control unit, a first supply line fluidly connected to the outlet of the tank, and a second supply line fluidly connected to the inlet of the engine, the heating installation comprising:
a first branch line fluidly connected between the first supply line and the second supply line; and
a second branch line fluidly connected between the first supply line and the second supply line,
   wherein a first valve, a heating system and a second valve are installed on each branch line in series, upstream to downstream, and are intended to be controlled by the control unit; the heating installation being characterized in that at least one of the heating systems comprises a first heat exchanger traversed by the corresponding first branch line, a burner comprising a first inlet, a second inlet, and an outlet, a first sub-line fluidly connected between the corresponding first branch line and the first inlet of the burner, a second sub-line fluidly connected between a pressurized air source and the second inlet of the burner, an extraction line intended to be fluidly connected between the outlet of the burner and the outside environment and that, between said outlet and said outside environment, traverses the first heat exchanger.

To this end, according to the invention, a heating installation is proposed for an aircraft comprising a tank that stores dihydrogen, an engine, a control unit, a first supply line fluidly connected to the outlet of the tank, and a second supply line fluidly connected to the inlet of the engine, the heating installation comprising:
a first branch line fluidly connected between the first supply line and the second supply line; and
a second branch line fluidly connected between the first supply line and the second supply line,
   wherein a first valve, a heating system and a second valve are installed on each branch line in series, upstream to downstream, and are intended to be controlled by the control unit; the heating installation being characterized in that at least one of the heating systems comprises a heat exchanger traversed by the corresponding branch line, a pre-combustion chamber installed on the corresponding branch line downstream of said heat exchanger, and a supply line that supplies air into the pre-combustion chamber, wherein, at the outlet of the pre-combustion chamber, the branch line traverses the heat exchanger in order to join the second valve.

To this end, according to the invention, a heating installation is proposed for an aircraft comprising a tank that stores dihydrogen, an engine, a control unit, a first supply line fluidly connected to the outlet of the tank, and a second supply line fluidly connected to the inlet of the engine, the heating installation comprising:
a first branch line fluidly connected between the first supply line and the second supply line; and
a second branch line fluidly connected between the first supply line and the second supply line,
   wherein a first valve, a heating system and a second valve are installed on each branch line in series, upstream to downstream, and are intended to be controlled by the control unit; the heating installation being characterized in that at least one of the heating systems comprises a first heat exchanger traversed by the corresponding first branch line, a second heat exchanger, a loop, in which a heat transfer fluid circulates and which successively traverses the first heat exchanger and the second heat exchanger, a burner comprising a first inlet, a second inlet and an outlet, a first sub-line fluidly connected between the corresponding first branch line and the first inlet of the burner, a second sub-line fluidly connected between a pressurized air source and the second inlet of the burner, an extraction line intended to be fluidly connected between the outlet of the burner and the outside environment and which, between said outlet and said outside environment, traverses the second heat exchanger.

Thus, the circuit followed by the dihydrogen is redundant. Depending on the use cases, it is then possible to select either one of the channels, for example, when the aircraft is in cruising flight or in the take-off phase.

Advantageously, the air supply line is intended to be fluidly connected between a compressor of the engine and the pre-combustion chamber and, between the engine and the pre-combustion chamber, the heating system comprises a cooler and a compressor installed on the supply line.

Advantageously, the pressurized air source comprises a three-way valve controlled by the control unit, with a first channel of the three-way valve being intended to be fluidly connected to a pressurized air source, a second channel of the three-way valve being intended to be fluidly connected to a compressor of the engine and a third channel of the three-way valve being fluidly connected to the second sub-line.

Advantageously, a turbine coupled to an electric generator is arranged on the extraction line between the outside environment and, as applicable, the first heat exchanger or the second heat exchanger.

Advantageously, the two heating systems are different.

The invention also proposes an aircraft comprising:
a tank that stores dihydrogen;
an engine;
a control unit;
a first supply line fluidly connected to the outlet of the tank;
a second supply line fluidly connected to the inlet of the engine; and
a heating installation according to any of the preceding variants, wherein the first branch line is fluidly connected between the first supply line and the second supply line, and wherein the second branch line is fluidly connected between the first supply line and the second supply line.

### BRIEF DESCRIPTION OF THE DRAWINGS

The aforementioned features of the invention, as well as other features, will become more clearly apparent upon reading the following description of an embodiment, with said description being provided with reference to the appended drawings, in which:

FIG. 1 is a side view of an aircraft according to the invention;

FIG. 2 is a schematic representation of a heating installation according to a main embodiment of the invention;

FIG. 3 is a schematic representation of a heating installation according to a first alternative embodiment of the invention;

FIG. 4 is a schematic representation of a heating installation according to a second alternative embodiment of the invention;

FIG. 5 is a schematic representation of a heating installation according to a third alternative embodiment of the invention;

FIG. 6 is a schematic representation of a heating installation according to a fourth alternative embodiment of the invention;

FIG. 7 is a schematic representation of a heating installation according to a fifth alternative embodiment of the invention;

FIG. 8 is a schematic representation of a heating installation resulting from a combination of the alternative embodiments of FIG. 3 and of FIG. 6; and

FIG. 9 is a representation of a hardware architecture of a control unit of the aircraft.

### DETAILED DESCRIPTION OF THE PREFERRED EMBODIMENTS

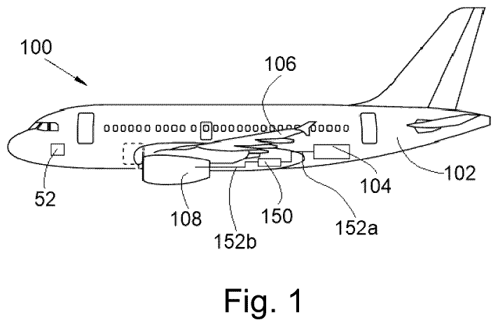

FIG. 1 shows an aircraft 100 that comprises a fuselage 102, which houses at least one tank 104 that stores dihydrogen, in particular liquid dihydrogen. The aircraft 100 also comprises a wing 106 on either side of the fuselage 102, with at least one engine 108 operating with gaseous dihydrogen being attached under each of said wings. The engine 108 is, for example, of the turbojet type and comprises a combustion chamber where the dihydrogen is combusted, at least one compressor upstream of the combustion chamber and at least one turbine downstream of the combustion chamber. According to a particular embodiment, the compressor of the engine 108 comprises a high-pressure compressor and a low-pressure compressor.

The aircraft 100 also comprises a control unit 52, a first supply line 152a fluidly connected to the outlet of the tank 104, and a second supply line 152b fluidly connected to the inlet of the engine 108 for supplying the combustion chamber.

The aircraft 100 also comprises a heating installation 150 according to the invention, arranged between the first supply line 152a and the second supply line 152b, for heating the dihydrogen exiting the tank 104 before it is introduced into the engine 108 and more specifically into the combustion chamber of the engine 108.

In the description, the “upstream” and “downstream” positions are to be taken relative to the direction of flow of the fluid flowing in the relevant elements.

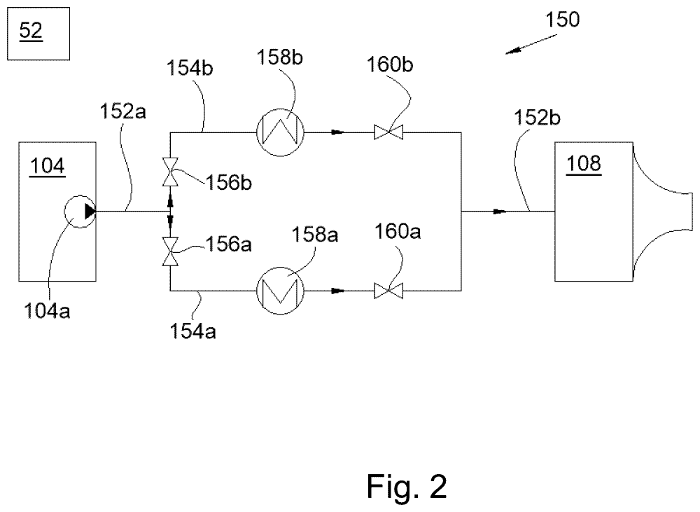

FIG. 2 shows the heating installation 150 between the tank 104 and the engine 108.

In the general embodiment of the invention, the heating installation 150 comprises:
a first branch line 154a fluidly connected between the first supply line 152a and the second supply line 152b; and
a second branch line 154b fluidly connected between the first supply line 152a and the second supply line 152b,
   wherein a first valve 156a-b, a heating system 158a-b and a second valve 160a-b are installed on each branch line 154a-b in series, upstream to downstream, i.e., between the first supply line 152a and the second supply line 152b.

The dihydrogen thus flows from the tank 104 to the engine 108 by successively traversing the first valve 156a-b, the heating system 158a-b and the second valve 160a-b.

All the valves described herein can be any type of valve (electrical, pneumatic, etc.) as long as they can be controlled by the control unit 52.

The control unit 52 thus controls each valve 156a-b, 160a-b and each heating system 158a-b according to the requirements of the dihydrogen engine 108. The control unit 52 controls, inter alia, the opening or closing of the valves 156a-b and 160a-b according to requirements.

The first supply line 152a takes dihydrogen from the tank 104. The dihydrogen present in the tank 104 is pressurized, thereby ensuring that the dihydrogen moves between the tank 104 and the engine 108, but, if necessary, a pressurization system 104a is installed at the outlet of the tank 104 in order to convey the dihydrogen in the first supply line 152a.

The second supply line 152b supplies gaseous dihydrogen to the inlet of the engine 108. The gaseous dihydrogen is supplied, for example, to a metering and injection system of the engine 108 that ensures that the amount of dihydrogen that is injected into the combustion chamber of the engine 108 is the amount required for the proper operation of said engine 108.

The first branch line 154a and the second branch line 154b are thus installed parallel to each other between the first supply line 152a and the second supply line 152b. Each heating system 158a-b heats the dihydrogen that passes through the associated branch line 154a-b to ensure that the dihydrogen changes phase.

Such a heating installation 150 is redundant since the dihydrogen can pass through either of the branch lines 154a-b depending on the requirements of the aircraft 100, and this selection is made by means of the control unit 52 that suitably controls each valve 156a-b, 160a-b.

Each heating system 158a-b ensures, for example, that very low temperature liquid dihydrogen (of the order of 20 K) is converted into gaseous dihydrogen at a temperature of 100 K to 500 K, preferably between 200 K and 300 K.

Each heating system 158a-b heats the dihydrogen while ensuring that engine thrust is available when needed. For example, each heating system 158a-b alone is capable of heating enough dihydrogen to ensure that the engine 108 produces at least half the demanded thrust during critical phases (for example, takeoff) and of heating enough dihydrogen to ensure that the engine 108 produces the demanded thrust during non-critical phases (for example, cruising).

According to one embodiment, a plurality of tanks can be connected in series or parallel to each heating installation on the first supply line 152a.

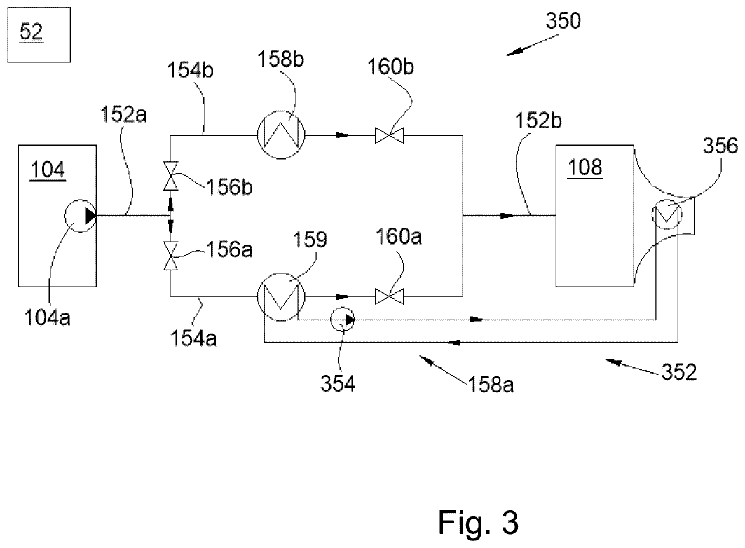

FIG. 3 shows an alternative embodiment of the heating installation 350 where the first heating system 158a comprises a first heat exchanger 159 traversed by the corresponding first branch line 154a, i.e., said corresponding first branch line enters through a first inlet of said first heat exchanger 159 and exits through a first outlet of said first heat exchanger 159. The first heat exchanger 159 is disposed between the first valve 156a and the second valve 160a.

The first heating system 158a comprises a second heat exchanger 356 and a loop 352, in which a heat transfer fluid flows, in this case by means of a pump 354, where the loop 352 traverses the second heat exchanger 356, which transfers heat from the engine 108 to the heat transfer fluid and where the loop 352 traverses the first heat exchanger 159 by entering through a second inlet of said first heat exchanger 159 and exiting through a second outlet of said first heat exchanger 159. The loop 352 traverses the second heat exchanger 356 by entering through a first inlet of said second heat exchanger 356 and exiting through a first outlet of said second heat exchanger 356.

Thus, the heat taken from the engine 108 heats the dihydrogen through the first heat exchanger 159.

The heat from the engine 108 can be taken from the exhaust gases from the nozzle of the engine 108 and/or from the oil of the engine 108.

The same installation can be implemented for the second heating system 158b and this then involves another first heat exchanger 159 and a loop 352 for each heating system 158a-b.

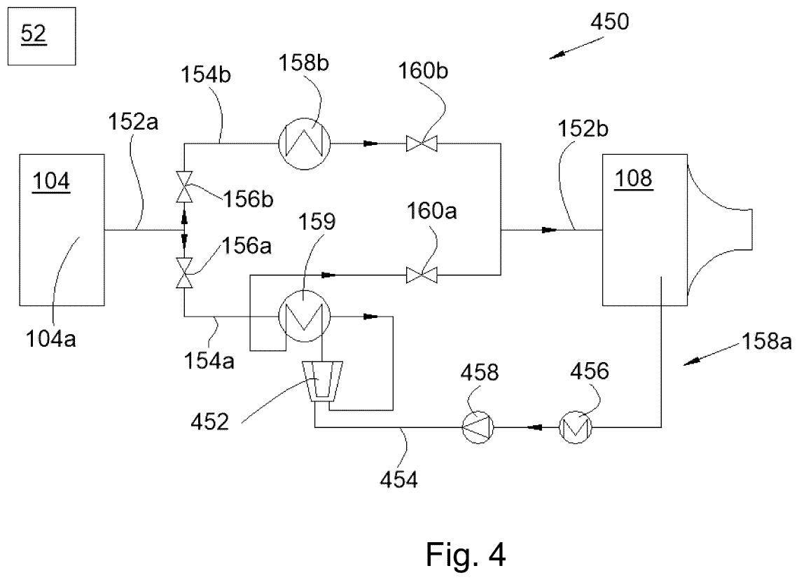

FIG. 4 shows an alternative embodiment of the heating installation 450, in which the first heating system 158a comprises a heat exchanger 159 traversed by the corresponding first branch line 154a, i.e., said corresponding first branch line enters through a first inlet of said heat exchanger 159 and exits through a first outlet of said heat exchanger 159. The first heat exchanger 159 is disposed between the first valve 156a and the second valve 160a.

Downstream of said heat exchanger 159, the heating system 158a comprises a pre-combustion chamber 452, which is installed on the first branch line 154a and in which the gaseous dihydrogen is mixed with air supplied to the pre-combustion chamber 452 through a supply line 454 of the heating system 158a.

In the pre-combustion chamber 452, an ignition system initiates the combustion of the mixture of dihydrogen and dioxygen in the air, which combustion is then self-sustaining.

The mixture output from the pre-combustion chamber 452 is introduced into a second inlet of said heat exchanger 159 and exits therefrom through a second outlet in order to join the second valve 160a through the branch line 154a.

The dihydrogen is then heated by transferring heat in the vicinity of the heat exchanger 159 where the dihydrogen originating from the tank 104 is heated and where the mixture exiting the pre-combustion chamber 452 is cooled before being injected into the engine 108.

The same installation can be implemented for the second heating system 158b and this then involves another heat exchanger 159 and a pre-combustion chamber 452 for each heating system 158a-b.

According to a particular embodiment, the air that is supplied by the supply line 454 is taken from the compressor of the engine 108 where the air supply line 454 is fluidly connected between the pre-combustion chamber 452 and the compressor of the engine 108, in particular the high-pressure compressor. The heating system 158a comprises, installed on the supply line 454, a cooler 456 for lowering the temperature of the air and a compressor 458 for increasing its pressure. In the embodiment of the invention shown in FIG. 4, the cooler 456 is upstream of the compressor 458 relative to the direction of flow of the air in the supply line 454, but inverse positions are possible.

The mixture present in the pre-combustion chamber 452 has excess dihydrogen compared to dioxygen and the exiting combustion gases predominantly comprise dihydrogen, water and nitrogen and all the dioxygen in the air has been consumed and converted into water.

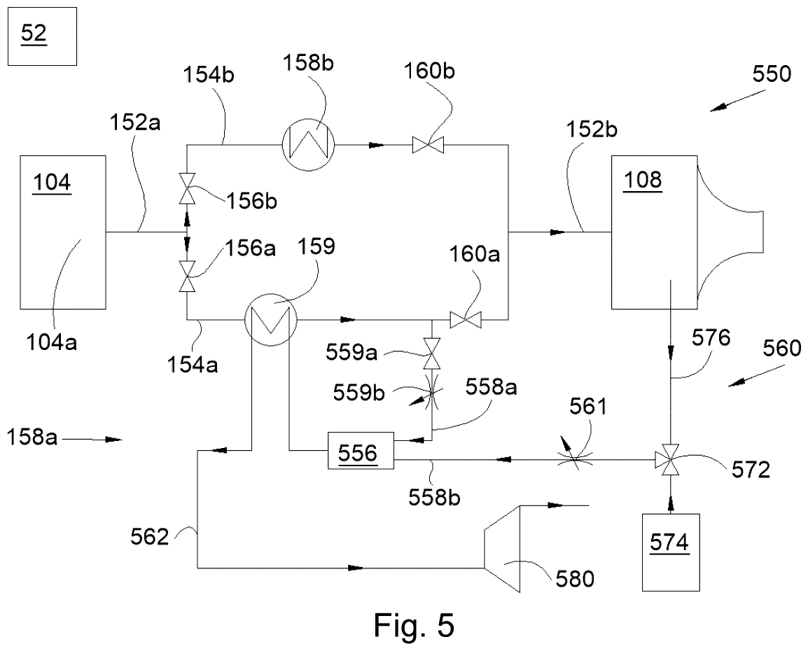

FIG. 5 shows an alternative embodiment of the heating installation 550, in which the first heating system 158a comprises a first heat exchanger 159 traversed by the corresponding first branch line 154a, i.e., said corresponding first branch line enters through a first inlet of said first heat exchanger 159 and exits through a first outlet of said first heat exchanger 159. The first heat exchanger 159 is disposed between the first valve 156a and the second valve 160a.

The first heating system 158a comprises a burner 556 where gases are combusted. The gases that are present are dihydrogen and dioxygen in the air where there is excess dioxygen compared to the dihydrogen, which is then fully combusted and converted into water.

In general, a burner 556 comprises a first inlet for introducing a first gas to be combusted, a second inlet for introducing a second gas to be combusted and an outlet for extracting gases originating from the combustion. The burner 556 is thus a lean combustion burner, i.e., the dioxygen is in excess compared to the dihydrogen. An ignition system initiates the combustion of the mixture of dihydrogen and dioxygen in the air, which combustion is then self-sustaining.

The first heating system 158a comprises a first sub-line 558a fluidly connected between the first inlet of the burner 556 and the first branch line 154a, for supplying hydrogen to the burner 556. The connection of the first sub-line 558a to the branch line 154a is located between the first heat exchanger 159 and the second valve 160a.

The first heating system 158a comprises a second sub-line 558b fluidly connected between a pressurized air source 560 and the second inlet of the burner 556.

The first heating system 158a comprises an extraction line 562, or discharge line, fluidly connected between the outlet of the burner 556 and the outside environment and which, between said outlet and said outside environment, traverses the first heat exchanger 159 by entering through a second inlet of the first heat exchanger 159 and exiting through a second outlet of the first heat exchanger 159.

The same installation can be implemented for the second heating system 158b and this then involves another heat exchanger 159 and a burner 556 for each heating system 158a-b.

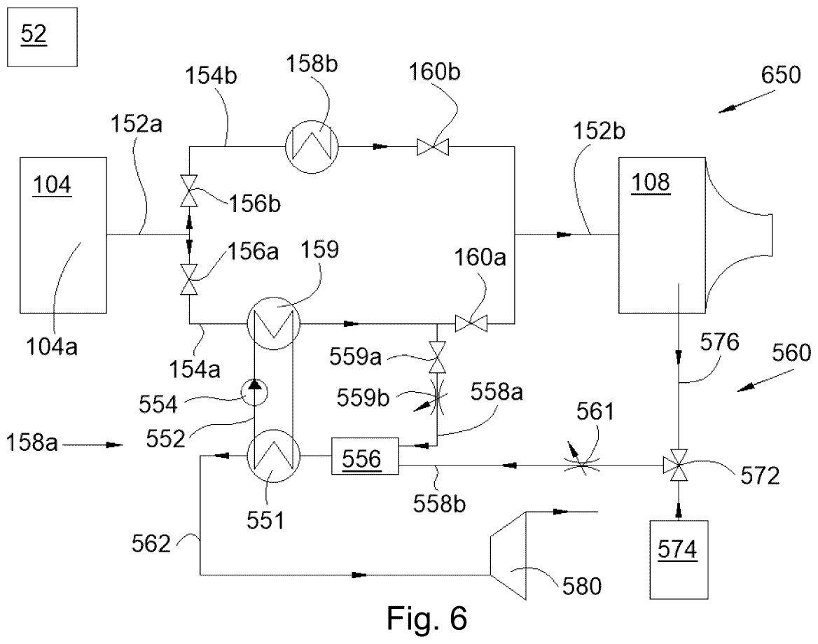

FIG. 6 shows an alternative embodiment of the heating installation 650, derived from the embodiment of FIG. 5, in which the first heating system 158a comprises a first heat exchanger 159 traversed by the corresponding first branch line 154a, i.e., said corresponding first branch line enters through a first inlet of said first heat exchanger 159 and exits through a first outlet of said first heat exchanger 159. The first heat exchanger 159 is disposed between the first valve 156a and the second valve 160a.

The first heating system 158a comprises a second heat exchanger 551 and a loop 552, in which a heat transfer fluid circulates, in this case by means of a pump or a compressor 554, where the loop 552 successively traverses the first heat exchanger 159 and the second heat exchanger 551. The loop 552 enters through a second inlet of the first heat exchanger 159 and exits through a second outlet of the first heat exchanger 159, and it enters through a first inlet of the second heat exchanger 551 and exits through a first outlet of the second heat exchanger 551.

The first heating system 158a comprises a burner 556 where gases are combusted. The burner 556 comprises a first inlet for introducing a first gas to be combusted, a second inlet for introducing a second gas to be combusted and an outlet for extracting the gases originating from the combustion. The burner 556 is thus a lean combustion burner as described above.

The first heating system 158a comprises a first sub-line 558a fluidly connected between the first inlet of the burner 556 and the first branch line 154a, between the first heat exchanger 159 and the second valve 160a.

The first heating system 158a comprises a second sub-line 558b fluidly connected between a pressurized air source 560 and the second inlet of the burner 556.

The first heating system 158a comprises an extraction line 562 fluidly connected between the outlet of the burner 556 and the outside environment and which, between said outlet and said outside environment, traverses the second heat exchanger 551 by entering through a second inlet of the second heat exchanger 551 and exiting through a second outlet of the second heat exchanger 551.

The same installation can be implemented for the second heating system 158b and this then involves another first heat exchanger 159 and a burner 556 for each heating system 158a-b.

In each of the embodiments of FIGS. 5 and 6, in order to regulate the amount of dihydrogen taken by the first sub-line 558a at the first branch line 154a, the first sub-line 558a is fitted with a flow control system controlled by the control unit 52 and which allows the flow of dihydrogen that is taken to be controlled. The control system in this case successively comprises, starting from the first branch line 154a, a control valve 559a and a flow control device 559b that are controlled by the control unit 52 and where the flow control device 559b can be in the form of a flow control valve or in the form of a calibrated hole.

In each of these embodiments, a fraction of the dihydrogen taken from the first branch line 154a is combusted in the burner 556 with the pressurized air. The gases originating from the combustion heat the dihydrogen through the first heat exchanger 159, directly in the case of FIG. 5, or through the loop 552 in the case of FIG. 6, before being conveyed to the outside environment.

In the embodiments of FIGS. 5 and 6, the pressurized air source 560 comprises a three-way valve 572 controlled by the control unit 52. A first channel of the three-way valve 572 is fluidly connected to a pressurized air source 574, a second channel of the three-way valve 572 is fluidly connected to a compressor of the engine 108 and a third channel of the three-way valve 572 is fluidly connected to the second sub-line 558b. According to an alternative embodiment, not shown, the compressor of the engine can be replaced by one or more other pressurized air sources.

The pressurized air source 574 supplies pressurized air and it can be a pressurized tank, an on-board compressor, etc.

The pressurized air source 574 is thus fluidly connected to the first channel of the three-way valve 572 and an air line 576 is fluidly connected between the engine 108 and the second channel of the three-way valve 572.

The air is preferably taken from the engine 108 at the intermediate level of the high-pressure compressor, or at the outlet of the low-pressure compressor, or at the supply circuit for the conditioned air.

With such an arrangement, the air can be supplied through the air line 576 when the engine 108 is operating and via the pressurized air source 574 when the engine 108 is stopped or unavailable.

In the embodiments of the invention shown in FIGS. 5 and 6, a flow control valve 561 controlled by the control unit 52 is arranged on the second sub-line 558b.

In the embodiments of the invention shown in FIGS. 5 and 6, the pressure at the outlet of the burner 556 is higher than the pressure of the ambient air and a turbine 580 is arranged on the extraction line 562 between the outside environment and, as applicable, the first heat exchanger 159 or the second heat exchanger 551, in order to reduce the pressure and to recover electrical energy through an electric generator coupled to the turbine 580.

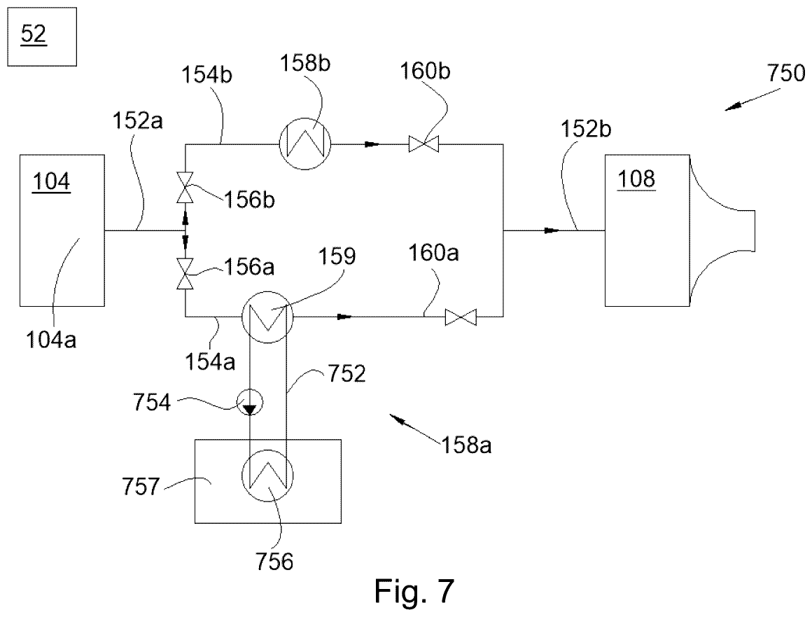

FIG. 7 shows an alternative embodiment of the heating installation 750 in which the first heating system 158a comprises a first heat exchanger 159 traversed by the corresponding first branch line 154a, i.e., said corresponding first branch line enters through a first inlet of said first heat exchanger 159 and exits through a first outlet of said first heat exchanger 159. The first heat exchanger 159 is disposed between the first valve 156a and the second valve 160a.

The first heating system 158a comprises a loop 752, in which a heat transfer fluid circulates, in this case by means of a pump 754 or a recirculator, where the loop 752 traverses a second heat exchanger 756 that transfers heat from a device 757 of the aircraft 100 to the heat transfer fluid and where the loop 752 traverses the first heat exchanger 159 by entering through a second inlet of said first heat exchanger 159 and exiting through a second outlet of said first heat exchanger 159. The loop 752 traverses the second heat exchanger 756 by entering through a first inlet of said second heat exchanger 756 and exiting through a first outlet of said second heat exchanger 756. The second heat exchanger 756 transfers heat from the device 757 housed in the aircraft 100 to the heat transfer fluid.

The device 757 is, for example, an auxiliary power generator, a fuel cell, the air conditioning system or any system on board the aircraft 100, i.e., in the fuselage 102, the wings 106 or in a nacelle of the engine 108.

Thus, the heat taken from the device 757 heats the dihydrogen through the first heat exchanger 159.

The same installation can be implemented for the second heating system 158b and this then involves another first heat exchanger 159 and a loop 752 for each heating system 158a-b.

The embodiments of FIGS. 3 and 7 can be generalized so that the second heat exchanger 356, 756 is arranged near a heat source (the engine 108 in the case of FIG. 3, the device 757 in the case of FIG. 7) and it transfers heat from the heat source (engine 108, device 757) to the heat transfer fluid. The heat source is hotter than the heat transfer fluid.

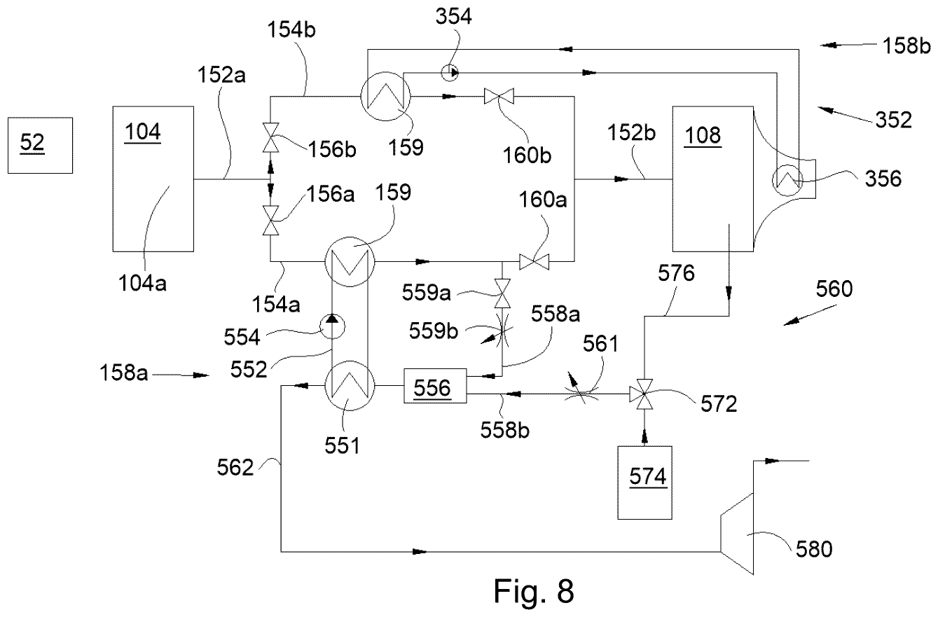

FIG. 8 shows an embodiment where the two heating systems 158a-b are different. In the embodiment of the invention shown in FIG. 8, the first heating system 158a conforms to that described in FIG. 6 and the second heating system 158b conforms to that described in FIG. 3. Of course, each of these heating systems 158a-b can be replaced with either of the heating systems 158a-b described in the various FIGS. 3-7.

Using two different technologies for each heating system 158a-b, the heating installation 150, 350, 450 is more resilient to a potential problem on one of the technologies or a particular operating mode. For example, some technologies can be used whether the engine 108 is operating or stopped and can allow the engine 108 to be restarted.

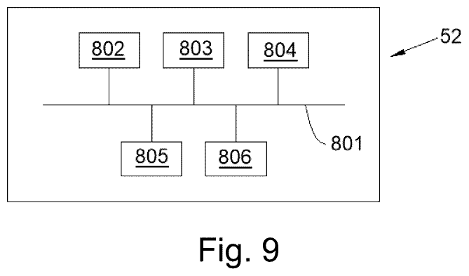

According to a particular embodiment shown in FIG. 9, the control unit 52 comprises, connected by a communication bus 801: a processor 802 or CPU (Central Processing Unit); a Random Access Memory (RAM) 803; a Read Only Memory (ROM) or Flash memory 804; a storage unit 805, such as a hard disk or a storage medium reader, such as an SD (Secure Digital) card reader; at least one communication interface 806, for example, allowing the control unit to communicate with the valves, the engine, the pumps, etc.

The processor is capable of executing instructions loaded into the RAM, upon powering up, from the ROM or Flash memory, an external memory (not shown), a storage medium (such as an SD card), or a communication network. When the equipment is powered on, the processor is capable of reading and executing instructions from the RAM. These instructions form a computer program causing the processor to implement some or all of the algorithms and steps described above.

All or some of the algorithms and steps described above can be implemented in software form by executing a set of instructions using a programmable machine, for example, a DSP (“Digital Signal Processor”) or a microcontroller, or can be implemented in hardware form by a dedicated machine or component, for example, a Field-Programmable Gate Array (FPGA) or an Application-Specific Integrated Circuit (ASIC),

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-8. (canceled)

9. A heating installation for an aircraft having a tank configured to store dihydrogen, an engine, a control unit, a first supply line fluidly connected to an outlet of the tank, and a second supply line fluidly connected to an inlet of the engine, the heating installation comprising:
a first branch line fluidly connected between the first supply line and the second supply line; and
a second branch line fluidly connected between the first supply line and the second supply line,
wherein a first valve, a heating system, and a second valve are installed on each branch line in series, upstream to downstream, and are configured to be controlled by the control unit,
wherein at least one of the heating systems comprises a first heat exchanger traversed by the respective branch line, a burner comprising a first inlet, a second inlet, and an outlet, a first sub-line fluidly connected between the corresponding branch line and the first inlet of the burner, a second sub-line fluidly connected between a pressurized air source and the second inlet of the burner, an extraction line configured to be fluidly connected between the outlet of the burner and an outside environment, and,
wherein the first heat exchanger traverses between said outlet and said outside environment.

10. The heating installation as claimed in claim 9, wherein the pressurized air source comprises a three-way valve controlled by the control unit, with a first channel of the three-way valve configured to be fluidly connected to a pressurized air source, a second channel of the three-way valve configured to be fluidly connected to a compressor of the engine and a third channel of the three-way valve fluidly connected to the second sub-line.

11. The heating installation as claimed in claim 9, further comprising:
a turbine, coupled to an electric generator, arranged on the extraction line between the outside environment and the first heat exchanger.

12. The heating installation as claimed in claim 9, wherein the heating systems are different.

13. An aircraft comprising:
a tank that stores dihydrogen;
an engine;
a control unit;
a first supply line fluidly connected to the outlet of the tank;
a second supply line fluidly connected to the inlet of the engine; and
the heating installation as claimed in claim 9,
wherein the first branch line is fluidly connected between the first supply line and the second supply line, and
wherein the second branch line is fluidly connected between the first supply line and the second supply line.

14. A heating installation for an aircraft having a tank configured to store dihydrogen, an engine, a control unit, a first supply line fluidly connected to an outlet of the tank, and a second supply line fluidly connected to an inlet of the engine, the heating installation comprising:
a first branch line fluidly connected between the first supply line and the second supply line; and
a second branch line fluidly connected between the first supply line and the second supply line,
wherein a first valve, a heating system, and a second valve are installed on each branch line in series, upstream to downstream, and are configured to be controlled by the control unit,
wherein that at least one of the heating systems comprises a heat exchanger traversed by the respective branch line, a pre-combustion chamber installed on the respective branch line downstream of the heat exchanger, and a supply line that supplies air into the pre-combustion chamber, and
wherein at an outlet of the pre-combustion chamber, the respective branch line traverses the heat exchanger in order to join the second valve.

15. The heating installation as claimed in claim 14, wherein the supply line is configured to be fluidly connected between a compressor of the engine and the pre-combustion chamber and
wherein, between the engine and the pre-combustion chamber, the heating system comprises a cooler and a compressor installed on the supply line.

16. The heating installation as claimed in claim 14, wherein the heating systems are different.

17. An aircraft comprising:
a tank that stores dihydrogen;
an engine;
a control unit;
a first supply line fluidly connected to the outlet of the tank;
a second supply line fluidly connected to the inlet of the engine; and
the heating installation as claimed in claim 14,
wherein the first branch line is fluidly connected between the first supply line and the second supply line, and
wherein the second branch line is fluidly connected between the first supply line and the second supply line.

18. A heating installation for an aircraft having a tank configured to store dihydrogen, an engine, a control unit, a first supply line fluidly connected to an outlet of the tank, and a second supply line fluidly connected to an inlet of the engine, the heating installation comprising:
a first branch line fluidly connected between the first supply line and the second supply line; and
a second branch line fluidly connected between the first supply line and the second supply line,
wherein a first valve, a heating system and a second valve are installed on each branch line in series, upstream to downstream, and are configured to be controlled by the control unit,
wherein at least one of the heating systems comprises a first heat exchanger traversed by the respective branch line, a second heat exchanger, a loop, in which a heat transfer fluid circulates and which successively traverses the first heat exchanger and the second heat exchanger, a burner comprising a first inlet, a second inlet, and an outlet, a first sub-line fluidly connected between the respective branch line and the first inlet of the burner, a second sub-line fluidly connected between a pressurized air source and the second inlet of the burner, an extraction line configured to be fluidly connected between the outlet of the burner and an outside environment, and
wherein, the second heat exchanger traverses between said outlet and said outside environment.

19. The heating installation as claimed in claim 18, wherein the pressurized air source comprises a three-way valve controlled by the control unit, with a first channel of the three-way valve configured to be fluidly connected to a pressurized air source, a second channel of the three-way valve configured to be fluidly connected to a compressor of the engine and a third channel of the three-way valve fluidly connected to the second sub-line.

20. The heating installation as claimed in claim 18, further comprising:
a turbine, coupled to an electric generator, arranged on the extraction line between the outside environment and the first heat exchanger or the second heat exchanger.

21. The heating installation as claimed in claim 18, wherein the heating systems are different.

22. An aircraft comprising:
a tank that stores dihydrogen;
an engine;
a control unit;
a first supply line fluidly connected to the outlet of the tank;
a second supply line fluidly connected to the inlet of the engine; and
the heating installation as claimed in claim 18,
wherein the first branch line is fluidly connected between the first supply line and the second supply line, and
wherein the second branch line is fluidly connected between the first supply line and the second supply line.
